(19) United States
(12) Patent Application Publication
(10) Pub. No.: US 2015/0113464 A1
(43) Pub. Date: Apr. 23, 2015

(54) INDICATOR SYSTEM

(71) Applicant: Caterpillar Inc., Peoria, IL (US)

(72) Inventors: Jeffrey A. Brush, Dunlap, IL (US); Kristen A. Gerstner, Peoria, IL (US)

(73) Assignee: Caterpillar Inc., Peoria, IL (US)

(21) Appl. No.: 14/578,510

(22) Filed: Dec. 22, 2014

(51) Int. Cl. G06F 3/0484; G06F 3/0481

(52) U.S. Cl. CPC G06F 3/04842; G06F 3/04817
USPC 715/772

(57) ABSTRACT

An indicator system for displaying an operating parameter of a machine includes a display unit configured to provide a display within a defined screen space of the display unit. A monitoring module communicably coupled to the display unit configured for receiving a signal indicative of the operating parameter of the machine; comparing the operating parameter with a predetermined range; determining if at least one of the operating parameter and a rate of change of the operating parameter exceeds the pre-determined range; and illuminating a first icon on the primary display. The monitoring module is also configured for displaying the signal indicative of the operating parameter of the machine on the secondary display; and illuminating a second icon on the secondary display, based on the first icon on the primary display, the second icon being positioned adjacent to the dial.

### TECHNICAL FIELD

The present disclosure relates to an indicator system for a machine, and more particularly towards real time monitoring and indicating of operating parameters of the machine during operation.

### BACKGROUND

Monitoring of operating parameters of machines, in particular earth moving machines like excavators, backhoes, tractors, dozers etc. are well known in the art. Such parameters are constantly monitored during machine operation and are provided to the operator of the machine. Traditionally, analog gages have provided the best solution for operators to effectively monitor critical machine parameters which have been replaced by display screens like LCD screens which may be placed inside or outside the machine.

Such LCD display screens may indicate machine speed, engine RPM such as a tachometer display, fuel level, coolant temperature, oil pressure, etc. and other commonly measured and displayed operating parameters during normal operation. In contrast, the display of a critical operating parameter which is operating outside the required or specified range such as, for example, engine over-temperature and low oil pressure may be communicated to the user visually, for example, by an alert light or an enlarged LCD visual disposed for viewing within the operator station of such machine.

It may be considered disadvantageous to structure a display with the standard operating parameters, for example, corresponding to normal operation being displayed in concert with the critical parameters in real time on an equal basis during normal operation. In so doing, the driver may become distracted and the display strategy may be too complicated and not appropriate for common machine operations. Moreover, if a certain display coinciding with critical operating parameters is displayed in real time and is therefore enlarged to increase the significance of such display, it may be distracting and consuming display space. As a result, operators may be commonly distracted by such mixed displays.

U.S. Pat. No. 7,565,230 describes a method for improving driver performance. The method includes assessment of a driver's performance during a course of drive, and providing feedback to the driver based on the assessment. The feedback provided to the driver includes alerts and warnings in the form of pre-recorded messages provided to the driver during a drive or after the drive. However, such pre-recorded messages may prove to be distracting for the driver. Further, the real time feedback may provide additional information about various operating parameters to the driver related to the vehicle, which may not be under the control of the driver.

Therefore, there is a need to provide an improved visual aid for assisting the operator of the machine.

### SUMMARY OF THE DISCLOSURE

In one aspect of the present disclosure, an indicator system for displaying an operating parameter of a machine is described. The indicator system includes a display unit configured to provide a display within a defined screen space of the display unit. A monitoring module communicably coupled to the display unit configured for receiving a signal indicative of the operating parameter of the machine; comparing the operating parameter with a pre-determined range; determining if at least one of the operating parameter and a rate of change of the operating parameter exceeds the pre-determined range; and illuminating a first icon on the primary display based on the user selection of the primary display. Based on the user selection of the secondary display, the monitoring module is configured for displaying the signal indicative of the operating parameter of the machine on the secondary display; and illuminating a second icon on the secondary display, based on the first icon on the primary display, the second icon being positioned adjacent to the dial on the secondary display.

Other features and aspects of this disclosure will be apparent from the following description and the accompanying drawings.

### BRIEF DESCRIPTION OF THE DRAWINGS

FIG. 1 illustrates an exemplary machine, according to one embodiment of the present disclosure;

FIG. 2 illustrates a schematic and diagrammatic view of an indicator system in application with the machine of FIG. 1, according to an embodiment of the present disclosure;

FIG. 3 illustrates a schematic and diagrammatic view of a primary display of the indicator system of FIG. 2 in one exemplary scenario, according to one embodiment of the present disclosure;

FIG. 4 illustrates a schematic and diagrammatic view of a secondary display of the indicator system of FIG. 2 in one exemplary scenario, according to one embodiment of the present disclosure;

FIG. 5 illustrates a schematic and diagrammatic view of the primary display of the indicator system of FIG. 2 in another exemplary scenario, according to some embodiments of the present disclosure; and

FIG. 6 illustrates a schematic and diagrammatic view of the secondary display of the indicator system of FIG. 2 in another exemplary scenario, according to some embodiments of the present disclosure

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

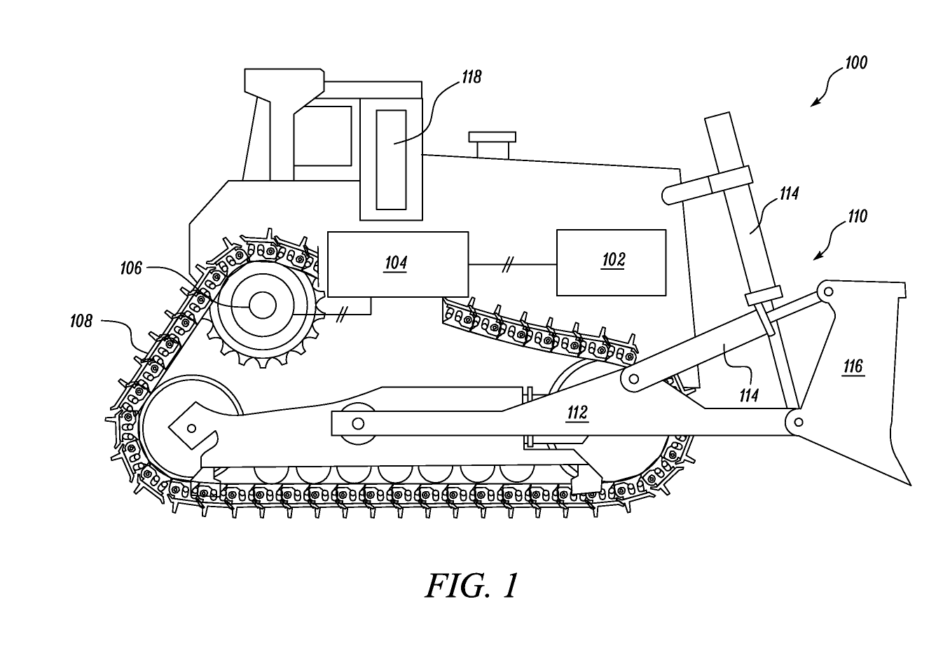

FIG. 1 illustrates an exemplary machine 100 according to one aspect of the present disclosure. As illustrated, the machine 100 is embodied as a track type tractor. Alternatively, the machine 100 may include, but is not limited to, a backhoe loader, a skid steer loader, a wheel loader, a motor grader or electrical power generation system. It should be understood that the machine 100 may embody any wheeled machine, tracked machine or power generation system associated with mining, agriculture, forestry, construction, power generation and other industrial applications.

As illustrated in FIG. 1, the machine 100 includes a power source 102, a transmission system 104, and a propulsion system 106. In one embodiment, the power source 102 may include, for example, a diesel engine, a gasoline engine, a gaseous fuel powered engine such as a natural gas engine, a combination of known sources of power or any other type of engine known to those having ordinary skill in the art. The transmission system 104 is communicably coupled to the power source 102. The transmission system 104 includes coupling elements for transmitting a drive torque from the power source 102 to the propulsion system 106. As illustrated in FIG. 1, the propulsion system 106 includes a tracked undercarriage 108 having ground engaging elements configured to propel the machine 100 along the ground.

Further, the machine 100 includes a load lifting assembly 110 having a lift arm 112, one or more hydraulic actuator 114 and a ground engaging tool 116. The ground engaging tool 116 is configured to collect, hold and convey material and/or heavy objects on the ground. The hydraulic actuators 114 are configured to effectuate the movement of the load lifting assembly 110 based on a user command provided by a user of the machine 100. The user command may be received through various input devices present within an operator's cab or user cabin 118 of the machine 100.

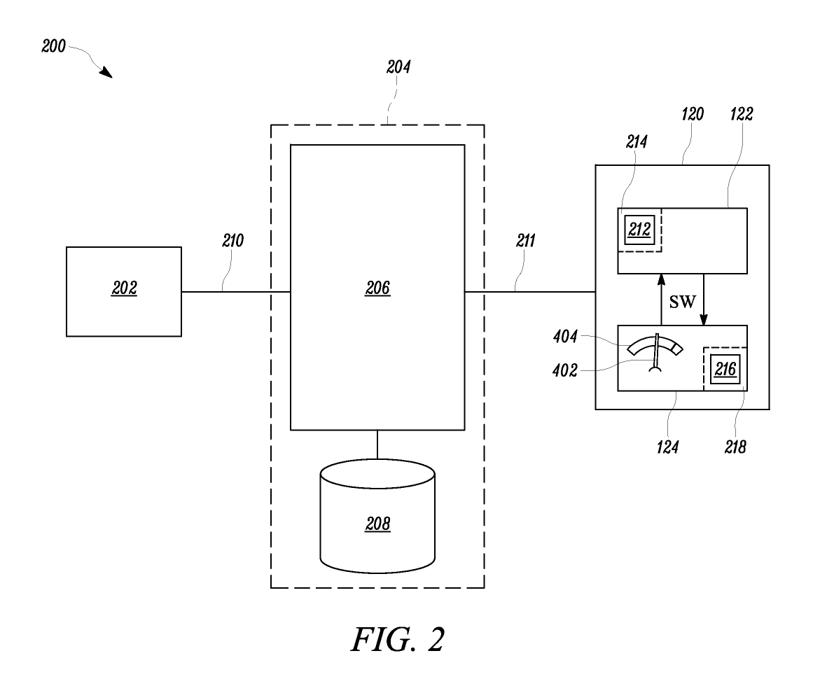

The user cabin 118 of the machine 100 also includes a display unit 120 (shown in FIG. 2). The display unit 120 is configured to display at least one output to the user of the machine 100 to aid the user in determining whether operational systems such as the power source 102, the transmission system 104 and the propulsion system 106 are operating properly and within proper limits. The display unit 120 may be an LCD, an LED, an OLED, a CRT or other devices for use with displaying operating parameters and being known to those having ordinary skill in the art. The display unit 120 may be a touchscreen device or any other touch or voice recognition equipment known in the art and being configured to display an output of the operating parameters including displays which may receive one or more inputs from a user of the machine 100.

FIG. 2 illustrates an indicator system 200 incorporated within the machine 100 according to an embodiment of the present disclosure. The indicator system 200 is configured to monitor and display an operating parameter of the machine 100. The operating parameter may relate to operating characteristics of various components of the machine 100. For example, the operating parameter may include an oil temperature associated with the power source 102, or the transmission system 104, hydraulic pressure associated with the propulsion system 106 or the load lifting assembly 110, temperature and viscosity of coolant of the power source 102, or any combination of such parameters known to one of ordinary skill in the art.

The indicator system 200 includes at least one electronic control module (ECM) 202. The ECM 202 of the machine 100 is in communication with various electrical components (not shown) of the machine 100, for example, with electrical subsystems (not shown) comprised of sensors, circuits, actuators or any other known component which may interface with, for example, the power source 102, the transmission system 104, the propulsion system 106, or the load lifting assembly 110 to animate the machine 100. Alternatively, the present disclosure contemplates a plurality of ECMs for use in the machine 100, as is customary for the purpose of powering the machine 100 and its subsystems to carry out. The ECM 202 may be configured to generate signals indicative of the operating parameters of the various electrical components and systems of the machine 100.

The machine 100 further includes a control tool 204 for coordinating and monitoring communication between the machine 100 and the ECM 202. The control tool 204 includes a monitoring module 206 and a database 208 in communication with the monitoring module 206. The monitoring module 206 may retrieve data from and store data in the database 208. The monitoring module 206 may be a computing microprocessor or any other similar microprocessor known in the art. The monitoring module 206 may include hardware specifically constructed for performing various processes and operations or may include a general purpose computer or computing platform selectively activated or reconfigured to provide required functionality. The monitoring module 206 is in communication with the ECM 202 via a datalink 210 for receiving data from, and sending instructions to the ECM 202. The datalink 210 may be a hardwire link or via wireless connection such as modem, infrared, or Bluetooth technology.

The monitoring module 206 is further in communication with the display unit 120 via datalink 211. The datalink 211 is similar to the datalink 210. As mentioned earlier, the display unit 120 may be an input and output device configured to display at least one output to the user and receive one or more inputs from the user of the machine 100. The display unit 120 is capable of displaying a plurality of displays to the user. The plurality of displays can be automated to change between displays in a desirable format or on user selection. The display unit 120 is positioned within the user cabin 118 of the machine 100. Alternatively, the display unit 120 may be positioned at a remote control station.

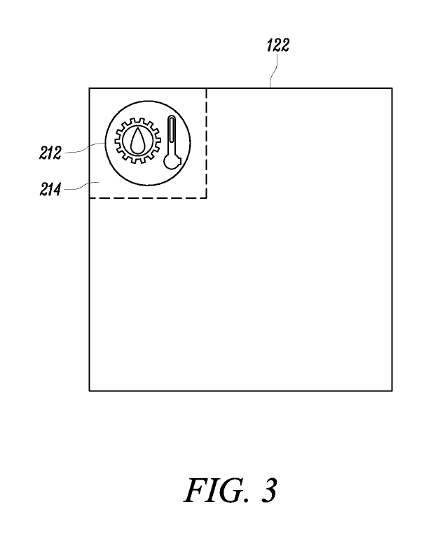

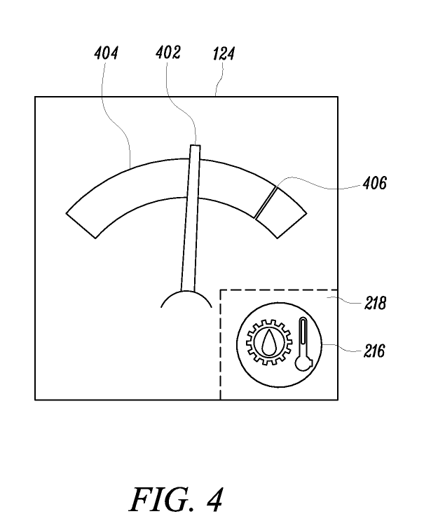

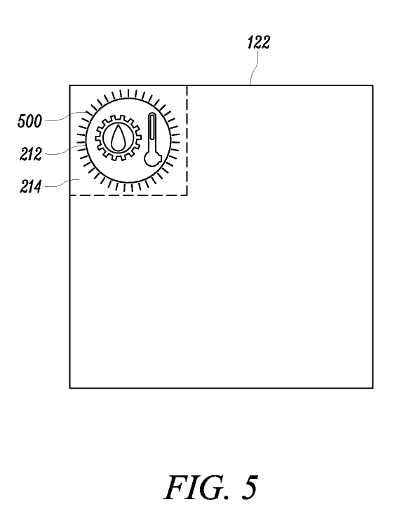

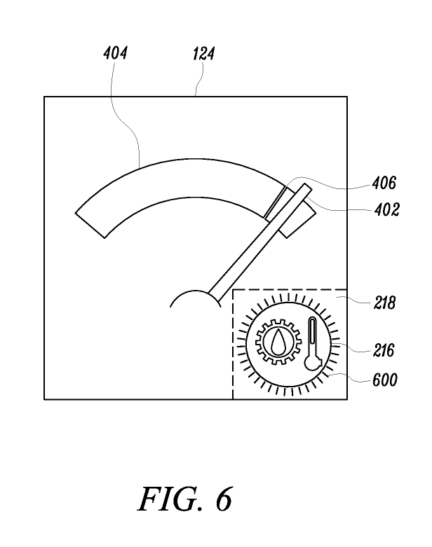

The display unit 120 is configured to display any one of a primary display 122 or a secondary display 124. Further, the primary display 122 may be within the secondary display 124 (FIGS. 4, 6) or independently (FIGS. 3, 5). The user may switch between the primary display 122 and the secondary display 124 in order to view one or more outputs pertaining to the operating parameters of the machine 100 that are displayed on the display unit 120. The user may select the primary display 122 to view a first representation of the operating parameters, and may alternatively select the secondary display 124 to view a second representation of the operating parameters of the machine 100.

Upon selection of the primary display 122 by the user on the display unit 120 for viewing the first representation of the operating parameters, the monitoring module 206 receives, from the ECM 202, a signal indicative of the operating parameters of the machine 100. The ECM 202 is communicably coupled to various components of the machine 100 and is configured to generate the signals indicative of the operating parameters of various components of the machine 100. For example, the operating parameter may be the oil temperature of the transmission system 104.

The monitoring module 206 receives a signal indicative of the oil temperature of the transmission system 104. Further, the monitoring module 206 is configured to compare the operating parameter, which is the oil temperature of the transmission system 104 in this case, with a pre-determined maximum temperature or within a pre-determined working range. The pre-determined range may be defined as a range of value(s) assigned to the operating parameters that defines an optimum and healthy working range of the machine 100. In context of the present disclosure, the pre-determined range may be a static range of values or a dynamic range of values within which the oil temperature reading must lie to ensure proper system operation.

Further, the monitoring module 206 may determine, based on the comparison with respect to the pre-determined range, whether the operating parameter or a rate of change of the operating parameter falls within the pre-determined range. The rate of change of the operating parameter may be defined as change in value(s) of the operating parameter over defined time interval during working of the machine 100. It will be understood that the rate of change of the operating parameter may be considered in order to estimate or predict a tendency of the operating parameter to fall out of the pre-determined based on prior readings. If the measurement of the operating range exceeds a pre-determined maximum value or limit, based on the current operating parameter reading or the rate of change of the operating parameter, then such a measurement will be deemed indicative of an unhealthy working of the machine 100. Such a scenario may be harmful for operation of the machine 100.

If the operating parameter or the rate of change of the operating parameter exceeds the pre-determined limit, as determined by the monitoring module 206, the monitoring module 206 alerts the user through the primary display 122. In context of the present disclosure, alerting the user by the monitoring module 206 may be defined as making the user aware of the working condition of the machine 100 based on the operating parameter reading of the machine 100. The user may accordingly modify his/her operating behavior to mitigate potential damage to the machine 100 and to re-establish the operating parameters within the predetermined range.

Alerting the user through the primary display 122 includes triggering an illumination event of a first icon 212 on a portion 214 of the screen space of the primary display 122. The first icon 212 is a scaled down and miniaturized representation of the monitored operating parameter. For example, the operating parameter may correspond to the oil temperature of the transmission system 104 and the first icon 212 may show an oil droplet in combination with a high temperature scale (see FIGS. 3 and 5) indicative of the oil temperature of the transmission system 104. Based on an illumination event or visibility of the first icon 212 on the primary display 122, the user may be alerted that the oil temperature of the transmission system 104 has exceeded the pre-determined threshold, thereby alerting the user of the machine 100 to take corrective action.

Further, as the user modifies working behavior of the machine 100 corresponding to a decreasing operating parameter or the rate of change of the operating parameter from the pre-determined limit, the illumination of the first icon 212 may stop resulting in first icon 212 disappearing, for example. In an alternate embodiment, to alert the user it is contemplated that illumination of the first icon 212 may be increased from a more dimly lit baseline. It may be also contemplated by the present disclosure that in addition to the illumination of the first icon 212 additional alert sequencing may take place such as audio, video, tactile, textual or other types of feedback known to those with ordinary skill in the art along with the illumination of the first icon 212.

As best seen in FIG. 2, upon selection of the secondary display 124 by the user to display unit 120, the second representation of operating parameters is viewable. The monitoring module 206 monitors the signal indicative of the operating parameter of the machine 100 and is further configured to display the operating parameter as a needle 402 and a dial 404 arrangement (will explained in detail in connection with FIGS. 4 and 6). The movement of the needle 402 over the dial 404 is indicative of change of the operating parameter or the rate of change of the operating parameter of the machine 100 during operation. The monitoring module 206 further compares the operating parameter or the rate of change of the operating parameter with the pre-determined limit. Alternatively, it is contemplated that the operating parameter reading be compared with a predetermined range and should the reading fall outside of the pre-determined range then the alert would manifest as hereinafter described.

If the operating parameter or the rate of change of the operating parameter exceeds the pre-determined limit, as determined by the monitoring module 206, the monitoring module 206 alerts the user through the secondary display 124. Alerting the user through the secondary display 124 includes triggering an illumination event of a second icon 216, based on the illumination event of the first icon 212 on the primary display 122. The second icon 216 is viewable on a portion 218 of a screen space of the secondary display 124.

The second icon 216, is a scaled down and miniaturized representation of the monitored operating parameter. For example, the operating parameter may correspond to the oil temperature of the transmission system 104 and the second icon 216 may be a representation of an oil droplet in combination with a high temperature scale (see FIGS. 4 and 6) and indicative of the oil temperature of the transmission system 104. The first and second icons 212, 216 have a similar representation on the primary and secondary displays 122, 124 respectively. In an embodiment, the second icon 216 is positioned adjacent to the needle 402 and the dial 404 arrangement on the secondary display 124. On selection of the secondary display 124 by the user, the needle 402 and the dial 404 arrangement may provide the user with detailed information regarding the current operating parameter reading in an analog manner, thereby allowing the user to understand the alert being illuminated by the first icon 212. However, once the operator parameter reading returns to the predetermined range then the illumination of the second icon 216 may disappear or cease being in synchronization with the first icon 212 as is desired and selected by the operator in set-up mode.

FIG. 3 illustrates a schematic view of an exemplary primary display 122 during normal operating condition of the machine 100. The normal operating condition is defined as a state of the machine 100 where the change in operating parameter or the rate of change of the operating parameter is within a pre-determined operating range and does not exceed the pre-determined limit monitored by the monitoring module 206. In this case the operating parameter is the oil temperature of the transmission system 104. Such a situation is depicted by reduced or no visibility or illumination of the first icon 212 on the primary display 122. As discussed earlier, the first icon 212 occupies the portion 214 on the primary display 122. The portion 214 is approximately one-third portion or lesser of the primary display 122. In alternative embodiments, the size and positioning of the first icon 212 over the primary display 122 may vary.

FIG. 4 illustrates a schematic view of the exemplary secondary display 124 in synchronization with the primary display 122 of FIG. 3 that is, during normal operating condition of the machine 100. As discussed earlier, the user may switch from the first display 122 shown in FIG. 3 to the secondary display 124 shown in FIG. 4 by the toggle or switching SW functionality (see FIG. 2) offered by the display unit 120. The normal operating condition is defined as a state of the machine 100 where the change in operating parameter or the rate of change of the operating parameter does not exceed the pre-determined limit 406 marked on the dial 404 on the secondary display 124 which is monitored by the monitoring module 206, as described earlier. In this case the operating parameter is the oil temperature of the transmission system 104. As shown by the position of the needle 402 on the dial 404 the operating parameter or the rate of change of the operating parameter is lesser than the pre-determined limit 406, and hence as the first icon 212 shown in FIG. 3 is not illuminated, even the second icon 216 on the secondary display 124 shown in FIG. 4 is not illuminated in synchronization with the first icon 212. Alternatively, it is contemplated that the operating parameter reading be compared with the predetermined range and should the reading fall within the pre-determined range then the first icon 212 and the second icon 216 are not illuminated. The second icon 216 is positioned proximate to the needle 402 and the dial 404 arrangement on the secondary display 124. In one embodiment, the positioning of the second icon 216 with respect to the needle 402 and the dial 404 arrangement may vary.

FIG. 5 illustrates a schematic view of the primary display 122 where the machine 100 is not working under normal operating conditions, i.e. the change in operating parameter or the rate of change of the operating parameter exceeds the pre-determined limit 406 monitored by the monitoring module 206. In this case the operating parameter is the oil temperature of the transmission system 104. Such a situation is depicted by an illuminated state 500 of the first icon 212 on the primary display 122. Alternatively, it is contemplated that the operating parameter reading be compared with the predetermined range and should the reading fall out of the pre-determined range then the illumination of the first icon 212 is triggered.

FIG. 6 illustrates a schematic view of the secondary display 124 where the machine 100 is not working under normal operating conditions, i.e. the change in operating parameter or the rate of change of the operating parameter exceeds the pre-determined limit 406 monitored by the monitoring module 206. In this case the operating parameter is the oil temperature of the transmission system 104. As indicated by the position of the needle 402 on the dial 404 indicating that the operating parameter has exceeded the pre-determined limit 406, and in synchronization with the illuminated state of the first icon 212 on the primary display 122 shown in FIG. 5, the user views an illuminated state 600 of the second icon 216 shown in FIG. 6 on the selection of the secondary display 124. Alternatively, it is contemplated that the operating parameter reading be compared with the predetermined range and should the reading fall out of the predetermined range then the illumination of the second icon 216 is triggered.

It may be contemplated that the machine 100 may include multiple display units 120 disposed in the user cabin 118. In an embodiment, the multiple display units 120 may be in communication with a plurality of monitoring modules 206, which may further be in communication with a plurality of electronic control modules (ECM) 202. Alternatively, a separate monitoring module 206 and a separate ECM 202 may be provided for each display unit 120. Further, the orientation and dimensions of the primary and the secondary displays 122, 124 as shown are not limited to that described herein.

### INDUSTRIAL APPLICABILITY

The present disclosure is relates to the indicator system 200 configured for monitoring and displaying the operating parameters associated with various components of the machine 100 under working conditions.

The monitoring module 206 monitors the operating parameter related to the machine 100 and checks if the operating parameter or the rate of change of operating parameter falls within the pre-determined range. If the operating parameter or the rate of change of operating parameter exceeds the predetermined limit or falls out of the pre-determined range a warning condition is reached, wherein the illumination event of the first icon 212 on the primary display 122 is used to alert the user. The illumination event of the second icon 216 adjacent to the needle 402 and the dial 404 on the secondary display 124 is synchronized with the illumination event of the first icon 212 on the primary display 122, such that the user may view the additional information of the current operating parameter reading indicating the measure of the current operating parameter. Further, by viewing the second icon 216 and the needle 402 and the dial 404 arrangement on the secondary display 124, the user may find it easy to compare these readings easily.

The components described with respect to the indicator system 200 are highly flexible and are easily configurable with conventional earth moving machines. Moreover, the same display space of the display unit 120 available to the user of the machine 100 is utilized effectively without overcrowding of the available space. Further, the user is able to closely monitor the machine 100 operating parameters in a plurality of orientations over a plurality of displays at his/her will. Thus, the user is effectively informed about normal and critical parameters associated with the working of earth moving machines. This increases operability and further enhances overall efficiency associated with the process as described.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An indicator system for displaying an operating parameter of a machine, the indicator system comprising:
a display unit configured to provide a display within a defined screen space of the display unit; and
a monitoring module communicably coupled to the display unit, the monitoring module configured to perform steps based on the user selection of the primary display, the steps comprising:
receiving a signal indicative of the operating parameter of the machine;
comparing the operating parameter with a pre-determined range;
determining if at least one of the operating parameter and a rate of change of the operating parameter exceeds the pre-determined range; and
illuminating a first icon on a portion of the screen space of the primary display based on the determination, wherein the first icon occupies approximately one-third portion of the screen space of the primary display, and wherein the first icon is a scaled representation of the operating parameter;
wherein the monitoring module is configured to perform steps based on the user selection of the secondary display, the steps comprising:
monitoring the signal indicative of the operating parameter of the machine;
displaying the monitored operating parameter on the secondary display; and
illuminating a second icon on the secondary display, based on the first icon on the primary display, the second icon being positioned adjacent to the dial on the secondary display.
